(19) United States
(12) Patent Application Publication
(10) Pub. No.: US 2017/0129616 A1
(43) Pub. Date: May 11, 2017

(54) METHOD FOR INSTALLING A DE-ICING SYSTEM ON AN AIRCRAFT, INVOLVING THE APPLICATION OF LAYERS OF MATERIAL IN THE SOLID AND/OR FLUID STATE

(71) Applicant: SAFRAN NACELLES, GONFREVILLE L'ORCHER (FR)

(72) Inventors: Caroline COAT-LENZOTTI, TOUSSUS LE NOBLE (FR); Olivier KERBLER, ANTONY (FR); Hakim MAALIOUNE, ORGEVAL (FR); Jean-Paul RAMI, LE HAVRE (FR)

(73) Assignee: SAFRAN NACELLES, GONFREVILLE L'ORCHER (FR)

(21) Appl. No.: 15/412,607

(22) Filed: Jan. 23, 2017

Related U.S. Application Data
(63) Continuation of application No. PCT/FR2015/052017, filed on Jul. 22, 2015.

(30) Foreign Application Priority Data
Jul. 22, 2014 (FR) 14/57079

(51) Int. Cl. B64D 15/12; B05D 1/28; B05D 1/02; B64F 5/10

(52) U.S. Cl. CPC B64D 15/12; B64F 5/10; B05D 1/28; B05D 1/02

(57) ABSTRACT

A method for installing a de-icing system on the skin of an aircraft element is provided, which involves applying to the skin several independent layers of solid and/or fluid materials which are hardened in succession, and which comprise at least one layer of controlled electrical resistivity material, which takes electrodes that conduct an electric current originating from an external source, which is flanked on each side by layers of an electrically insulating material.

### CROSS-REFERENCE TO RELATED APPLICATIONS

This application is a continuation of International Application No. PCT/FR2015/052017, filed on Jul. 22, 2015, which claims the benefit of FR 14/57079 filed on Jul. 22, 2014. The disclosures of the above applications are incorporated herein by reference.

### FIELD

The present disclosure relates to a method for setting up a de-icing system of an aircraft skin, and a turbojet engine nacelle including inlet lips having a de-icing system deposited with such a method.

### BACKGROUND

The statements in this section merely provide background information related to the present disclosure and may not constitute prior art.

The leading edges of aircraft, in particular the surrounding of the air inlet of the cowls of turbojet engines and more generally any leading edge of a nacelle such as for example some types of variable geometry nozzles, forming forward facing bulged flanges, may under certain climatic conditions such as the crossing of clouds with a low temperature, present the formation of frost which ends up constituting ice blocks.

Therefore, an increase in weight of the structure is obtained, which may cause both a lateral imbalance of the aircraft, and a loss of the aerodynamic qualities by a poor air flow over this irregular surface. Furthermore, in case of air inlet from the turbojet engine, a detachment of ice blocks which return into this machine, and damage blades of the fan and the compressors may be obtained. The flight clearances in icing conditions require the presence of a de-icing system.

In order to avoid the formation of frost on the concerned surfaces, a known method, presented in particular by the document EP-A2-1495963, includes the deposition on the surfaces of a bonded multi-layered complex comprising electrically conductive grids forming resistors, electrically and thermally insulating layers, and a honeycomb structure intended to reduce acoustic emissions.

A power supply is provided for each grid, in order to locally adjust both the power consumption and the released calorific value.

However, the deposition of conductive grids is not always easy on curved surfaces which may be complex, in order to obtain a sufficiently homogeneous assembly including a thermal power regularly distributed thereon.

The spacing of the conductive wires inside the grid also gives a defect of homogeneity of the heating of the surface, with a higher temperature near the wires, and lower temperature in the meshes between the wires. The thermal efficiency depending on the electrical power consumption is not optimized.

Furthermore, in case of damage of the conductive grid, caused for example by an impact which cuts the conductive wires of this grid, a complete disabling of the concerned grid, resulting in an entire surface which is no longer protected against frost.

Moreover, by using a grid integrated in insulating layers, forming a soft mat deposited and bonded on the surface, there is a risk of formation of bubbles below this mat which would generate heat exchanges, in particular on the surfaces comprising a pronounced curvature where it may be more difficult for the mat to follow a small radius.

### SUMMARY

The present disclosure provides a method for setting up a system for de-icing an outer skin of an aircraft element, noteworthy in that it includes the deposition on the skin of several independent layers of solid and/or fluid materials which are successively cured, comprising at least one controlled electrical resistivity material layer, receiving electrodes conducting an electric current coming from an external source, which is surrounded on each side by layers of an electrically insulating material.

An advantage of this setting-up method is that by using a controlled electrical resistivity material such as a paint charged with low-conductive carbon particles, there is simply and economically produced a variable and calibrated thickness layer on outer surfaces of the aircraft which may be complex, comprising different curvatures which may be pronounced, giving with a supply by the judiciously disposed electrodes, a homogeneous thermal power on all these surfaces.

In particular, the controlled resistivity layer is protected against external current leakage by the two electrically insulating layers surrounding it, which may be in the same manner easily set up on complex surfaces with the deposition method of fluid layers.

The method of setting-up the de-icing system according to the present disclosure may also include one or more of the following features, which may be combined therebetween.

Advantageously, the setting-up method includes the deposition of several electrically independent sectors of the electrical resistivity material. It is accordingly possible to specifically control the thermal power of each surface covered by a sector.

Advantageously, the setting-up method includes the deposition on the inner side of the de-icing system, of a thermally insulating layer. Thus, the heat losses inwardly of the structure are limited.

Advantageously, the method includes the deposition on the outer side of the de-icing system, of a lightning protection layer.

Advantageously, the method includes the deposition on the outer side of the assembly, of a final layer of external erosion protection.

Advantageously, the method includes the deposition of a controlled electrical resistivity material layer comprising a polyurethane paint having carbon particles giving the controlled electrical resistivity thereto. This material is easy to implement, by giving good strength.

In particular, the method may include the deposition of a controlled electrical resistivity material layer, in a thickness comprised between about 0.05 mm and 0.5 mm. Thus, it is possible to obtain an appropriate electrical resistance.

In addition, the method may include a step for depositing a second skin spaced from the first skin by the de-icing system.

In addition, the method may include a step for depositing temperature sensors integrated in the controlled electrical resistivity material layer. These sensors allow performing an accurate regulation of the temperature, thereby improving the energy consumption.

In addition, the deposition of the controlled electrical resistivity material layer is performed on the inner face of said skin.

The present disclosure also relates to a turbojet engine nacelle comprising an outer skin forming a lip surrounding the upstream air inlet, which includes a de-icing system set up by a method comprising any one of the preceding features.

The present disclosure also relates to a method for repairing a nacelle in accordance with the above, in which said layers are repaired by sanding, possible installation of a patch in case of a hole, and re-deposition of said layers in the area to be repaired.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional diagram of a de-icing device manufactured according to a method of the present disclosure, disposed inside a metal inner skin;

FIG. 2 is alternatively a diagram of a de-icing device disposed outside a metal inner skin;

FIG. 3 is alternatively a diagram of a de-icing device disposed outside a composite material skin;

FIG. 4 is alternatively a diagram of a de-icing device disposed between two skins of composite or metallic or combined material (a metal skin and a composite skin); and

FIG. 5 is alternatively a diagram of a de-icing device disposed inside a composite material skin.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

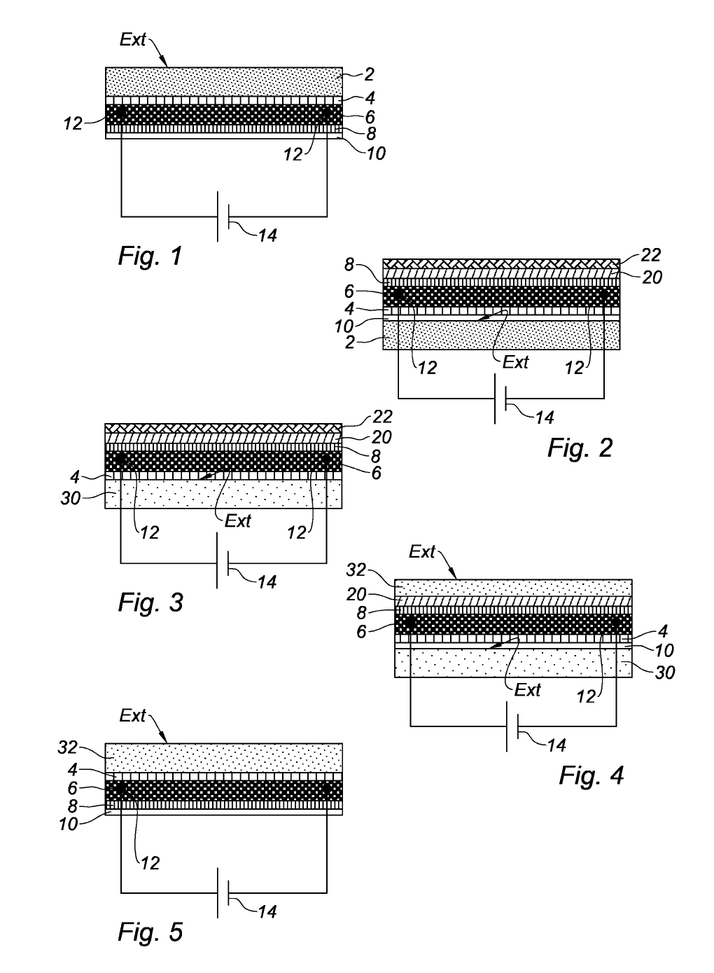

FIG. 1 shows the rigid outer metal skin 2 of a structure of an aircraft, including an upper surface Ext forwardly facing this structure, which may be subjected to the deposition of frost. The metal skin 2 may include in particular an alloy of aluminum or titanium.

The metal skin 2 receives on its inner surface fluid materials which are successively polymerized, to constitute a first layer forming a first electrical insulator 4, a second layer comprising a controlled electrical resistivity material 6, a third layer forming a second electrical insulator 8, and a fourth layer forming a heat insulator 10.

The electrically insulating layers 4, 8 and with electrical resistivity 6 each comprise a viscous fluid material such as a paint, which is deposited for example by brush, by roller or by spraying, so as to obtain a defined thickness depending in particular on the viscosity, the application type and the number of successive applications. An alternative would include depositing one or more layers in the form of films, the materials of these films being therefore in the solid state.

Two electrodes 12 disposed in the thickness of the electrical resistivity layer 6, and connected by electrical wires to a current generator 14, form the positive and negative poles allowing supplying this layer with a controlled power current depending on the needs of de-icing.

It is in particular possible to vary the thickness of the electrical resistivity 6 layer depending on the areas to be treated, so as to obtain a variable resistance, and a suitable heating thermal capacity according to these areas.

The two electrically insulating layers 4, 8 inhibit current losses outside the electrical resistivity material 6, in order to obtain improved heat efficiency of this material depending on the electrical power consumption.

The final thermally insulating layer 10 enables limiting the heat losses inwardly of the structure in order to make increased use of the calories released by Joule effect to heat the outer metal skin 2 and to melt the frost deposited thereon or to inhibit the formation of said frost.

It is in particular possible to deposit the electrical resistivity material 6 with its electrodes 12 according to delimited sectors, thereby allowing independently heating different surfaces of the structure. The heating of the sectors may be in particular specifically made for each sector according to the local needs of de-icing. It can also be alternatively made between the sectors in order to limit the instantaneous electrical power consumption.

Advantageously, the electrical resistivity material 6 comprises a polyurethane paint loaded with carbon particles, which gives it a low electrical resistivity.

In addition, the electrical resistivity material 6 may receive temperature sensors, in order to control the driving of the heating of different sectors in order to perform an electrical power regulation depending on the measured temperature, and an improved efficiency of the energy consumption.

By using for the different layers of materials a fluid material such as a paint deposited on the surface, an intimate contact of these layers is provided over the entire surface, while avoiding the formation of bubbles therebelow which would form an insulation locally hindering the heat exchange.

In particular, it is possible to produce an electrical resistivity layer 6 of a thickness comprised between 0.05 mm and 0.5 mm. By adapting the dimension and the position of the electrodes depending on the available electrical voltage and the expected power, it is accordingly possible to obtain a thermal power of several kW/m², evenly distributed over the entire surface, regardless of the variable curvatures that the air inlets of the turbojet engines may have or more generally may be applicable to any leading edge of a nacelle such as for example certain type of variable geometry nozzle or the leading edges of the wings.

A low and homogeneous temperature which saves energy and a rise in temperature which may be rapid are obtained. The electrical current drain which may be continuous current, a passive electrical system having a low electromagnetic emission is provided, which reduces generating disturbances.

Furthermore, in case of a local surface accident, following the impact of an object for example, the assembly of the electrical conduction formed by the sector of the resistivity layer 6 is not reached, this sector may continue to heat with a decreased efficiency, it is not completely broken down.

In order to perform the repair of a sector, it is possible to locally sand the failure, and to repair the different layers in this area with the successive depositions of the original materials. It is also possible to start again the whole sector if necessary, by sanding it completely in order to start again at the start the method of deposition of the different layers. Thus, it is possible to simply and economically repair the defects of the de-icing means/device.

FIG. 2 shows the rigid metal skin 2 including an outwardly facing upper surface Ext, which receives by the successive deposition of polymerized fluid materials, a layer forming a heat insulator 10, a layer forming a first electrical insulator 4, an electrical resistivity material 6 layer, and a layer forming the second electrical insulator 8 of this material.

A lightning protection layer 20 is then deposited which is electrically conductive, and a layer 22 forming a resistant outer erosion protection surface.

It is noteworthy that this description is not restrictive; indeed, it can be envisaged that a single layer might both provide the protection against lightning and erosion (therefore fusion of the layers 20 and 22).

Similarly, it is possible to imagine that a future evolution of the paint 6 can perform several functions, such as, for example, a paint 6 providing the lightning protection.

It will be noted that the heat insulator 10 is deposited firstly so as to form the inwardly insulation limiting the losses of calories/heat on this side, in order to obtain increased heating of the outer surface of the final erosion protection layer 22, subjected to the deposition of frost.

FIG. 3 shows a rigid skin 30 made of a monolithic or sandwich composite material including carbon fibers, successively receiving on its outwardly facing upper surface Ext, a first electrical insulating layer 4, a controlled electrical resistivity material 6 layer, and a second electrical insulating layer 8 of this material.

A lightning protection layer 20 is then deposited, and a layer of external erosion protection 22 is deposited.

It will be noted that the rigid skin 30 made of composite material naturally forming a heat insulator, it is possible to dispense with the thermal insulation layer provided beforehand for a thermally conductive skin.

FIG. 4 shows a structure composed of two rigid skins 30, 32 made of monolithic or sandwich or metallic or combined composite material, spaced by the superposition of the layers deposited according to the method according to the present disclosure, thereby giving a very rigid assembly.

A thermal insulating layer 10, a first electrical insulating layer 4, an electrical resistivity material 6 layer and a second electrical insulating layer 8 of this material 8 are successively deposited on the outer surface Ext of the lower skin 30.

A lightning protection layer 20 is then deposited. Finally, the upper rigid skin 32 is deposited by directly molding it on this assembly, which forms an external erosion protection.

Alternatively, the layers may be conversely deposited on the inside of the upper rigid skin 32, to end with the lower rigid skin 30.

It will be noted that the first thermal insulating layer 10 deposited on the lower skin 30, may not be used if this first skin constitutes a sufficient thermal insulation which does not need to be doubled.

FIG. 5 shows a structure composed of a single upper rigid skin 32 made of a monolithic or sandwich composite material, directly located on the outside, which receives the layers superimposed on the inner face thereof.

A first electrical insulating layer 4, an electrical resistivity material 6 layer, and a second electrical insulating layer 8 of this material are successively deposited on the inner face of the upper skin 32.

Finally, a final layer of internal thermal insulation 10 is deposited, which limits the losses of calories/heat inwardly of the structure.

The method according to the present disclosure accordingly enables covering all outer skin types, thermally conductive or not, by the inside or the outside of this skin depending on the possibilities, in order to obtain a particularly homogeneous de-icing system and including a good efficiency.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for manufacturing a de-icing system for a skin of an aircraft member comprising deposition on the skin of several independent layers of solid and/or fluid materials which are successively cured, comprising at least one layer of controlled electrical resistivity material, receiving electrodes conducting an electrical current coming from an external source, the at least one layer of controlled electrical resistivity material having sides and being surrounded on each side by layers of an electrically insulating material.

2. The method according to claim 1 further comprising deposition of a plurality of electrically independent sectors of the electrical resistivity material.

3. The method according to claim 1 further comprising deposition of a thermally insulating layer on an inner side of the de-icing system.

4. The method according to claim 1 further comprising deposition of a lightning protection layer on an outer side of the de-icing system.

5. The method according to claim 1 further comprising deposition of a layer of external erosion protection on an outer side of the de-icing system.

6. The method according to claim 1 further comprising deposition of a controlled electrical resistivity material layer comprising a polyurethane paint having carbon particles.

7. The method according to claim 1 further comprising deposition of a controlled electrical resistivity material layer in a thickness between about 0.05 mm and 0.5 mm.

8. The method according to claim 1 further comprising depositing a second skin spaced from the skin by the de-icing system.

9. The method according to claim 1 further comprising depositing temperature sensors integrated in the layer of controlled electrical resistivity material.

10. The method according to claim 1 further comprising deposition of the layer of controlled electrical resistivity material on an inner face of said skin.

11. A turbojet engine nacelle comprising an outer skin forming a lip surrounding an upstream air inlet, wherein the outer skin includes a de-icing system manufactured according to the method of claim 1.

12. A method for repairing a nacelle in accordance with claim 11, wherein said layers are repaired by sanding and re-deposition of said layers in the area to be repaired.

13. The method according to claim 12, wherein a patch is installed after the sanding.
